(19) United States
(12) Patent Application Publication
(10) Pub. No.: US 2009/0070732 A1
(43) Pub. Date: Mar. 12, 2009

(54) Fracture Shot Count Reduction

(75) Inventors: Emile Sahouria, Sunnyvale, CA (US); Jianlin Wang, Mountain View, CA (US)

Correspondence Address: MENTOR GRAPHICS CORP.;PATENT GROUP, 8005 SW BOECKMAN ROAD, WILSONVILLE, OR, 97070-7777, US

(73) Assignee: Mentor Graphics Corporation, Wilsonville, OR (US)

(21) Appl. No.: 11/925,606

(22) Filed: Oct. 26, 2007

Related U.S. Application Data
(60) Provisional application No. 60/971,461, filed on Sep. 11, 2007.

(51) Int. Cl. G06F 17/50

(52) U.S. Cl. 716/20

(57) ABSTRACT

Techniques are described for reducing the number of shots in a fractured layout design. Each polygon in a layout design is examined for “jogs.” For each identified jog, the surrounding region is examined to determine if there is an opposing jog or parallel edge that can be aligned with the identified jog. The surrounding region then is examined for any polygon features, such as edges or vertices, which might restrict or prevent the alignment of the identified jog with the opposing jog or edge. If the identified jog can be aligned with an opposing jog or edge without violating a specified alignment constraint, then those jogs are deemed an alignable jog pair. Next, one or more of the alignable jog pairs is selected for alignment. The alignable jog pairs may be selected for alignment based upon their impact on the size of the polygon when aligned. Once one or more of the alignable jog pairs have been selected, then the layout design data will be modified to align the selected jog pairs.

### RELATED APPLICATIONS

This application claims priority under 35 U.S.C. 119 to U.S. Provisional Patent Application No. 60/971,461, filed on Sep. 11, 2007, entitled “Fracture Shot Count Reduction” and naming Emile Y. Sahouria and Jainlin Wang as inventors, which provisional patent application is incorporated entirely herein by reference.

### FIELD OF THE INVENTION

The present invention is directed to the reduction of shot counts in fractured layout design data. Various aspects of the invention may be particularly useful in creating fractured layout design data that will be more efficiently processed by vector-scanning type reticle or mask writers.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires will be formed to connect the circuit devices. Typically, a designer will perform a number of analyses on the layout design. For example, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

In particular, the design flow process may include one or more resolution enhancement technique (RET) processes. These processes will modify the layout design data, to improve the usable resolution of the reticle or mask created from the design in a photolithographic manufacturing process. One such family of resolution enhancement technique (RET) processes, sometimes referred to as optical proximity correction (OPC) processes, may add features such as serifs or indentations to existing layout design data in order to compensate for diffractive effects during a lithographic manufacturing process. For example, as shown in FIG. 1, an optical proximity correction process may modify a polygon 101 in a layout design to include a “hammerhead” shape 103, in order to decrease rounding of the photolithographic image at the corners of the polygon.

After the layout design has been finalized, it is converted into a format that can be employed by a mask or reticle writing tool to create a mask or reticle for use in a photolithographic manufacturing process. Masks and reticles typically are made using tools that expose a blank reticle or mask substrate to an electron or laser beam (or to an array of electron beams or laser beams). Most mask writing tools are able to only “write” certain kinds of polygons, however, such as right triangles, rectangles or other trapezoids. Moreover, the sizes of the polygons are limited physically by the maximum beam (or beam array) size available to the tool. Accordingly, larger geometric elements in the layout design, or geometric elements that are not right triangles, rectangles or trapezoids (which typically are a majority of the geometric elements in a layout design) must be “fractured” into the smaller, more basic polygons that can be written by the mask or reticle writing tool. For example, FIG. 2 illustrates a polygon 201 in a layout design. In order for a mask or reticle writing tool to write this polygon 201 as a set of trapezoids, the polygon 201 must be fractured into three different component polygons or “shots” 203A-203C. This process sometimes is referred to as “mask data preparation.”

Once a layout design has been fractured into shots, then the fractured layout design data can be converted to a format compatible with the mask or reticle writing tool. Examples of such formats are MEBES, for raster scanning machines manufactured by ETEC, an Applied Materials Company, and various vector scan formats for Nuflare, JEOL, and Hitachi machines, such as VSB11 or VSB12. The written masks or reticles then can be used in a photolithographic process to expose selected areas of a wafer to light or other radiation in order to produce the desired integrated circuit devices on the wafer.

A significant consideration to conventional photolithographic manufacturing processes is the size of the fractured layout design, which can be very large. For example, one layout data file for a single layer of a field programmable gate array may be approximately 58 gigabytes. As a result, the process of writing a fractured layout design is extremely expensive, both in terms of computing resources and write time. Improvements in the efficiency and speed of creating masks or reticles thus are continually being sought.

Most reticle or mask writers are either raster-scanning or vector-scanning. With raster-scanning mask or reticle writers, the writing beam traverses the mask substrate from one side to the opposite side in a straight line, while the mask substrate typically is moved orthogonal to the direction of the beam. The writer then interrupts the beam for those areas (e.g., pixels) where a geometric element should not be formed. Alternately, the reticle or mask writer may use some type of gray-scaling technique to generate the desired geometric elements without interrupting the beam. The time required to write a reticle or mask using a raster-scanning writer thus will largely be independent of the overall design being written to the mask or reticle. With vector scanning mask or reticle writers, however, the writer moves the beam to only those areas of the mask substrate where a shot should be written. The mask writer will then either scan the area of the shot with the beam using, e.g., a raster pattern, or it will vary the shape of the beam to write as much of the shot as possible at one time. As a result, the time required to write a reticle or mask using a vector-scanning writer will correspond closely to the number of shots in the fractured layout design.

### BRIEF SUMMARY OF THE INVENTION

Aspects of the invention relate to techniques for reducing the number of shots in a fractured layout design. Various examples of the invention may be particularly useful in reducing the reticle or mask writing time of a vector-scanning reticle or mask writer by reducing the number of shots generated during a fracturing process.

According to various implementations of the invention, each polygon in a layout design is examined for “jogs.” For each identified jog, the surrounding region is examined to determine if there are any opposing jogs or parallel edges that can be aligned with the identified jog. As used herein, the term “jog pair” will be used to refer to the combination of an identified jog and an opposing jog that can be aligned with the identified jog. For convenience and ease of understanding, the term “jog pair” also will be used herein to refer to the combination of an identified jog with an opposing, parallel edge that can be aligned with the identified jog. Once the jog pairs have been determined, the surrounding region then is examined for any polygon features, such as edges or vertices, which might restrict or prevent the alignment of the identified jog with an opposing jog or edge. If the identified jog can be aligned with an opposing jog or edge without violating a specified alignment constraint, then those jogs are deemed an alignable jog pair.

One or more of the alignable jog pairs then will be selected for alignment. With some implementations of the invention, the alignable jog pairs may be selected for alignment based upon their impact on the size of the polygon when aligned. That is, a particular set of alignable jogs may be selected that, when aligned, will minimize the impact of the alignments on the polygon. For example, a particular set of alignable jog pairs may be selected that, when aligned, will minimize the area change of the polygon. Alternately, a particular set of alignable jog pairs may be selected that, when aligned, will minimize the total movement of the edges (including jog edges) of the polygon. Once one or more of the alignable jog pairs have been selected, then the layout design data will be modified to align the selected jog pairs.

According to various examples of the invention, this alignment process may be incorporated into a larger resolution enhancement technique (RET) process. For still other examples of the invention, however, a jog alignment process may alternately or additionally be implemented as a stand-alone process. These and other features and aspects of the invention will be discussed in more detail below.

### BRIEF DESCRIPTION OF THE DRAWINGS

FIG. 1 illustrates an example of a correction of layout design data that may be made by an optical proximity correction process.

FIG. 2 illustrates an example of fracturing of a polygon in a layout design.

FIGS. 3A-3C illustrate the alignment of jogs in a layout design polygon to reduce the number of shots required to write the polygon onto a mask or reticle.

FIG. 4 illustrates a computing system that may be used to implement various embodiments of the invention.

FIG. 5 illustrates an example of a multi-core processor unit that may be used to implement various embodiments of the invention.

FIG. 6 schematically illustrates an example of a shot count reduction tool that may be implemented according to various embodiments of the invention.

FIGS. 7A and 7B illustrate a flowchart showing the operation of a shot count reduction tool that may be implemented according to various embodiments of the invention.

FIG. 8 illustrates an example of a jog that may be aligned with an opposing jog or edge according to various embodiments of the invention.

FIG. 9 illustrates a polygon in a layout design that may be modified to reduce its shot count according to various embodiments of the invention.

FIG. 10 illustrates an arrangement of two polygons in a layout design that may prohibit the alignment of jogs in one of the polygons according to various embodiments of the invention.

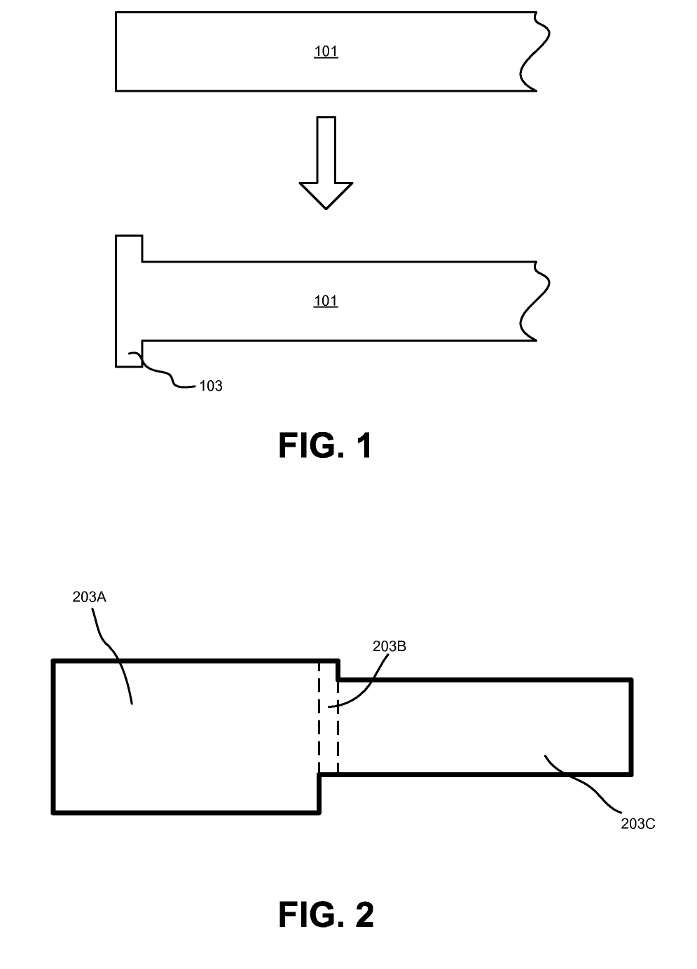

### DETAILED DESCRIPTION OF THE INVENTION

### Overview

Various implementations of the invention relate to techniques or systems for reducing the shot count of fractured layout design data. As will be discussed in more detail below, polygons in layout design data are examined to identify alignable jog pairs One or more of the alignable jog pairs are then aligned, thereby reducing the shot count required to fracture the polygon.

Referring back to FIG. 2, this figure illustrates a polygon 201 in a layout design. With a conventional fracture process, the polygon 201 must be fractured into a minimum of three separate shots 203A-203C. Moreover, because the amount of time required to write a pattern using a vector scanning reticle or mask writer closely corresponds to the number of shots in the pattern, the need to write the shot 203B may substantially increase the overall time required to write the polygon 201 to a mask or reticle.

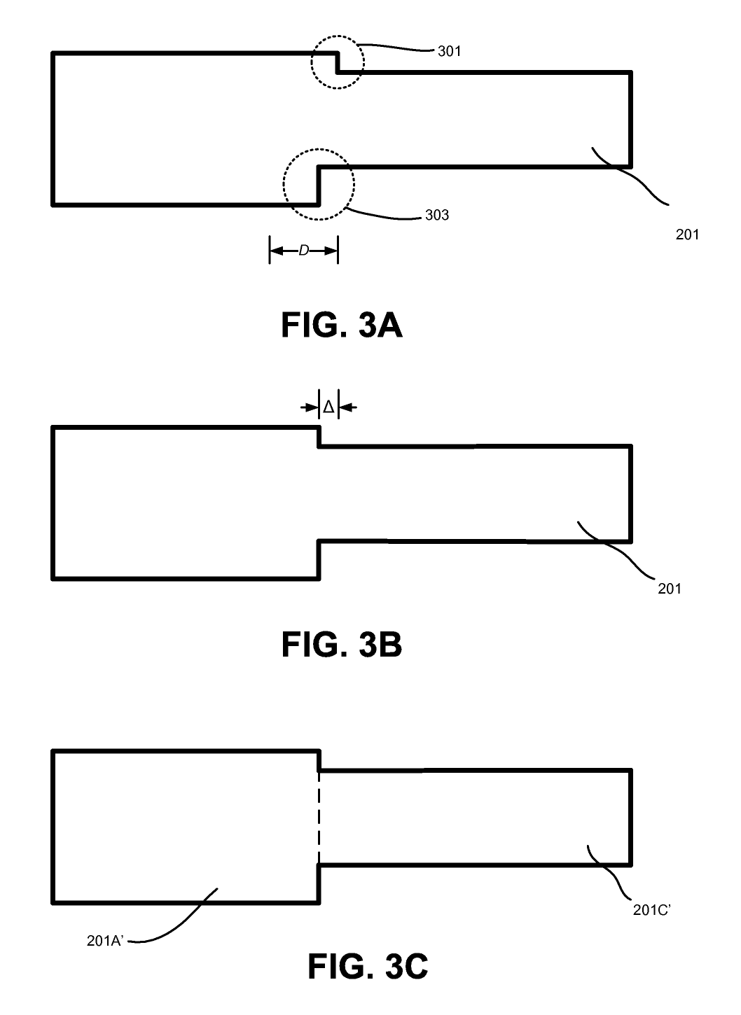

As will be discussed in more detail below, various implementations of the invention can identify the two “jogs” 301 and 303 in the polygon 201, as seen in FIG. 3A. Further, these implementations of the invention can then move the jog 301 toward the jog 303 by a displacement distance Δ (as shown in FIG. 3B), to align the jog 301 with the jog 303. Once the jogs 301 and 303 are aligned, the polygon 201 can be fractured into only two shots 201A′ and 201C′, as illustrated in FIG. 3C.

### Exemplary Operating Environment

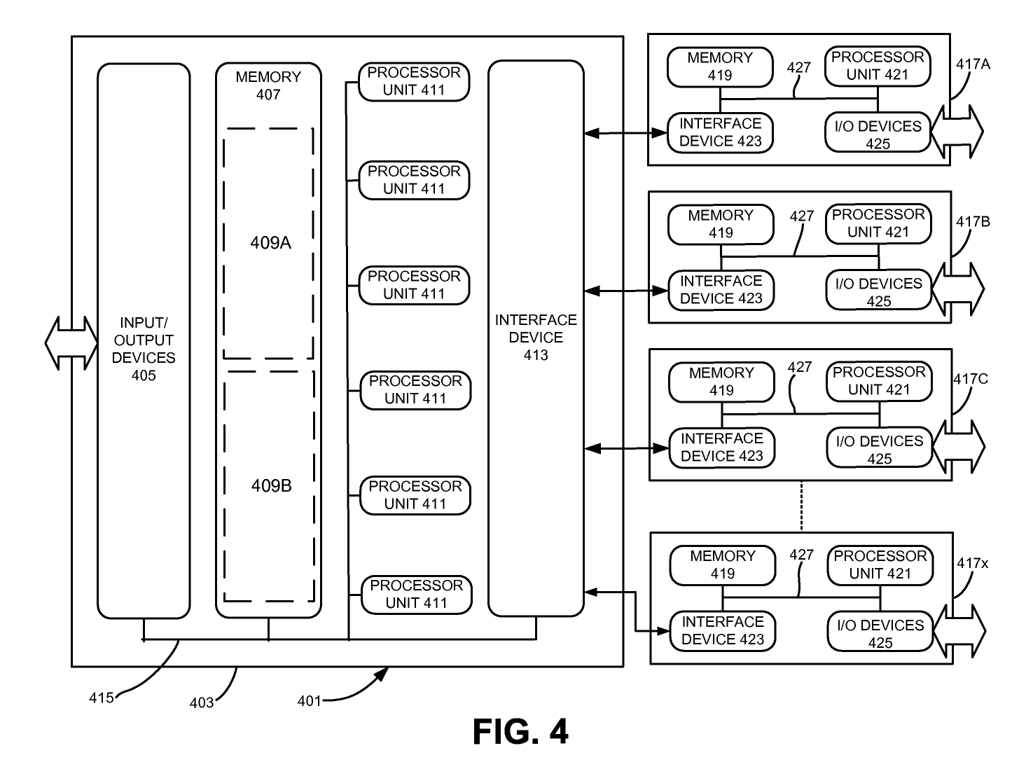

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 4. This operating environment is only one example of a suitable operating environment, however, and is not intended to suggest any limitation as to the scope of use or functionality of the invention.

In FIG. 4, the computer network 401 includes a master computer 403. In the illustrated example, the master computer 403 is a multi-processor computer that includes a plurality of input and output devices 405 and a memory 407. The input and output devices 405 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 407 may similarly be implemented using any combination of computer readable media that can be accessed by the master computer 403. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 403 runs a software application for performing one or more operations according to various examples of the invention. Accordingly, the memory 407 stores software instructions 409A that, when executed, will implement a software application for performing one or more operations. The memory 407 also stores data 409B to be used with the software application. In the illustrated embodiment, the data 409B contains process data that the software application uses to perform the operations, at least some of which may be parallel.

The master computer 403 also includes a plurality of processor units 411 and an interface device 413. The processor units 411 may be any type of processor device that can be programmed to execute the software instructions 409A, but will conventionally be a microprocessor device. For example, one or more of the processor units 411 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 411 may be a custom-manufactured processor, such as a microprocessor designed to optimally perform specific types of mathematical operations. The interface device 413, the processor units 411, the memory 407 and the input/output devices 405 are connected together by a bus 415.

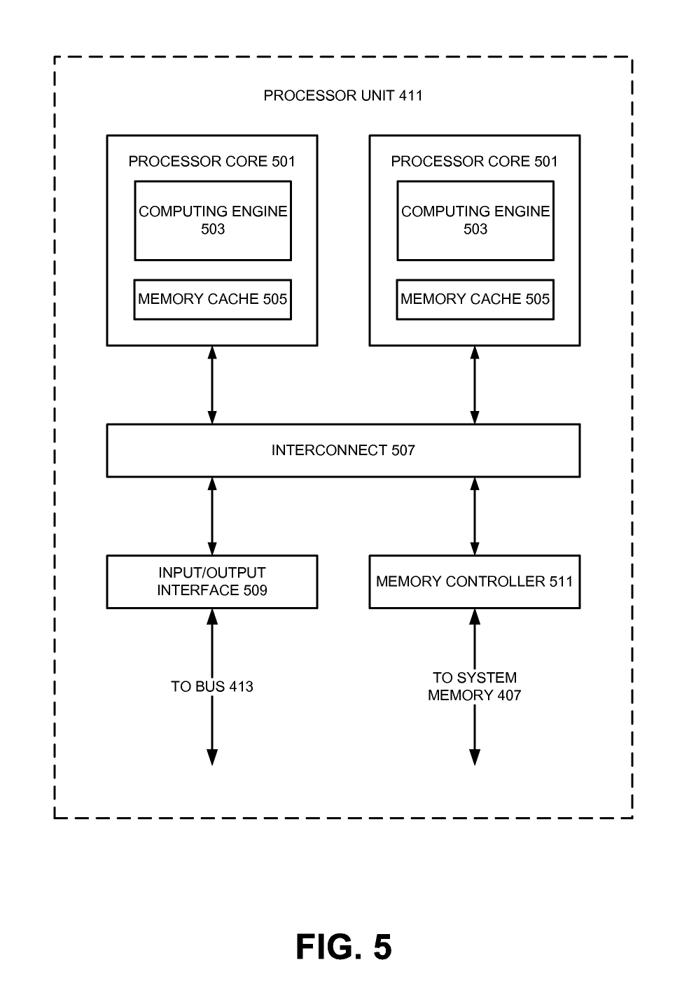

With some implementations of the invention, the master computing device 403 may employ one or more processing units 411 having more than one processor core. Accordingly, FIG. 5 illustrates an example of a multi-core processor unit 411 that may be employed with various embodiments of the invention. As seen in this figure, the processor unit 411 includes a plurality of processor cores 501. Each processor core 501 includes a computing engine 503 and a memory cache 505. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 503 may then use its corresponding memory cache 505 to quickly store and retrieve data and/or instructions for execution.

Each processor core 501 is connected to an interconnect 507. The particular construction of the interconnect 507 may vary depending upon the architecture of the processor unit 501. With some processor cores 501, such as the Cell microprocessor created by Sony Corporation, Toshiba Corporation and IBM Corporation, the interconnect 507 may be implemented as an interconnect bus. With other processor units 501, however, such as the Opteron™ and Athlon™ dual-core processors available from Advanced Micro Devices of Sunnyvale, Calif., the interconnect 507 may be implemented as a system request interface device. In any case, the processor cores 501 communicate through the interconnect 507 with an input/output interface 509 and a memory controller 511. The input/output interface 509 provides a communication interface between the processor unit 501 and the bus 415. Similarly, the memory controller 511 controls the exchange of information between the processor unit 501 and the system memory 407. With some implementations of the invention, the processor units 501 may include additional components, such as a high-level cache memory accessible shared by the processor cores 501.

While FIG. 5 shows one illustration of a processor unit 501 that may be employed by some embodiments of the invention, it should be appreciated that this illustration is representative only, and is not intended to be limiting. For example, some embodiments of the invention may employ a master computer 403 with one or more Cell processors. The Cell processor employs multiple input/output interfaces 509 and multiple memory controllers 511. Also, the Cell processor has nine different processor cores 501 of different types. More particularly, it has six or more synergistic processor elements (SPEs) and a power processor element (PPE). Each synergistic processor element has a vector-type computing engine 503 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 411 can be used in lieu of multiple, separate processor units 411. For example, rather than employing six separate processor units 411, an alternate implementation of the invention may employ a single processor unit 411 having six cores, two multi-core processor units each having three cores, a multi-core processor unit 411 with four cores together with two separate single-core processor units 411, etc.

Returning now to FIG. 4, the interface device 413 allows the master computer 403 to communicate with the servant computers 417A, 417B, 417C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 413 translates data and control signals from the master computer 403 and each of the servant computers 417 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 417 may include a memory 419, a processor unit 421, an interface device 423, and, optionally, one more input/output devices 425 connected together by a system bus 427. As with the master computer 403, the optional input/output devices 425 for the servant computers 417 may include any conventional input or output devices, such as keyboards, pointing devices, microphones, display monitors, speakers, and printers. Similarly, the processor units 421 may be any type of conventional or custom-manufactured programmable processor device. For example, one or more of the processor units 421 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 421 may be custom-manufactured processors, such as microprocessors designed to optimally perform specific types of mathematical operations. Still further, one or more of the processor units 421 may have more than one core, as described with reference to FIG. 5 above. For example, with some implementations of the invention, one or more of the processor units 421 may be a Cell processor. The memory 419 then may be implemented using any combination of the computer readable media discussed above. Like the interface device 413, the interface devices 423 allow the servant computers 417 to communicate with the master computer 403 over the communication interface.

In the illustrated example, the master computer 403 is a multi-processor unit computer with multiple processor units 411, while each servant computer 417 has a single processor unit 421. It should be noted, however, that alternate implementations of the invention may employ a master computer having single processor unit 411. Further, one or more of the servant computers 417 may have multiple processor units 421, depending upon their intended use, as previously discussed. Also, while only a single interface device 413 or 423 is illustrated for both the master computer 403 and the servant computers, it should be noted that, with alternate embodiments of the invention, either the computer 403, one or more of the servant computers 417, or some combination of both may use two or more different interface devices 413 or 423 for communicating over multiple communication interfaces.

With various examples of the invention, the master computer 403 may be connected to one or more external data storage devices. These external data storage devices may be implemented using any combination of computer readable media that can be accessed by the master computer 403. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 417 may alternately or additionally be connected to one or more external data storage devices. Typically, these external data storage devices will include data storage devices that also are connected to the master computer 403, but they also may be different from any data storage devices accessible by the master computer 403.

It also should be appreciated that the description of the computer network illustrated in FIG. 4 and FIG. 5 is provided as an example only, and it not intended to suggest any limitation as to the scope of use or functionality of alternate embodiments of the invention.

Layout Data Fracturing Tool

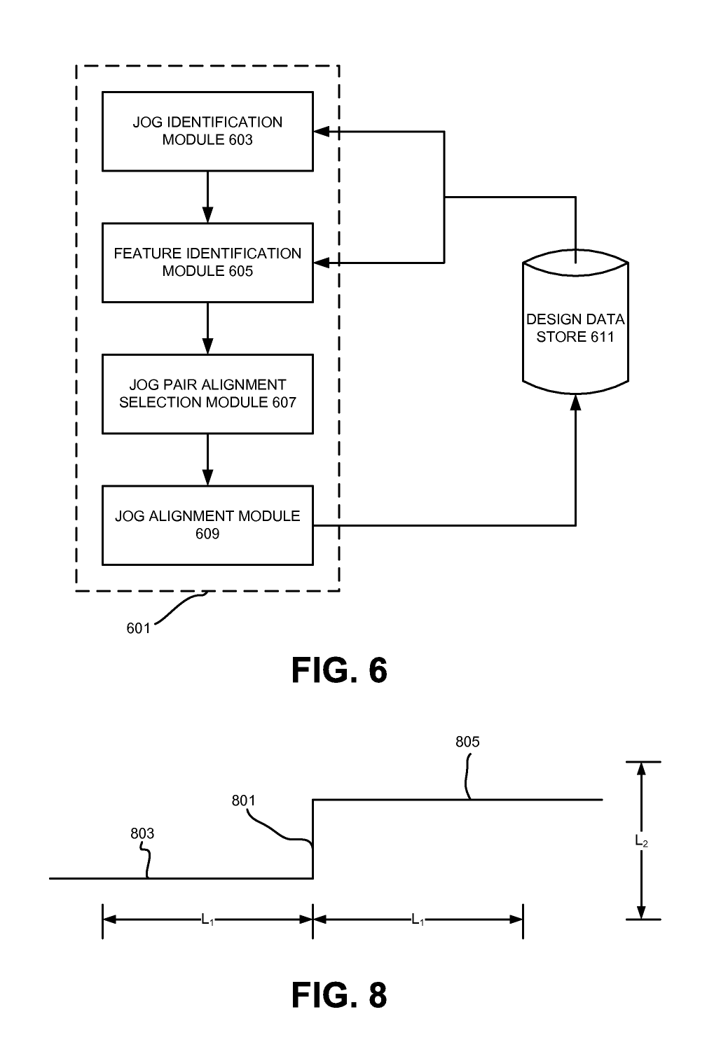

FIG. 6 illustrates an example of a shot count reduction tool 601 that may be implemented according to various examples of the invention. As seen in this figure, the shot count reduction tool 601 includes a jog identification module 603, a feature identification module 605, a jog pair alignment selection module 607, and a jog alignment module 609. As previously noted, various examples of the invention may be implemented by a multiprocessor computing system, such as the multiprocessor computing system 401 illustrated in FIG. 4. Accordingly, one or more components of each of the jog identification module 603, the feature identification module 605, the jog pair alignment selection module 607 and the jog alignment module 609 may be implemented using one or more processors in a multiprocessor computing system's master computer, such as the master computer 403, one or more servant computers in a multiprocessor computing system, such as the servant computers 417, or some combination of both. It also should be appreciated that, while the jog identification module 603, the feature identification module 605, the jog pair alignment selection module 607, and the jog alignment module 609 are shown as separate units in FIG. 6, a single servant computer (or a single processor within a master computer) may be used to implement two or more of these modules at different times.

The shot count reduction tool 601 may work with a design data store 611. The design data store 611 may be any data storage device that is capable of storing design data and accessible to the shot count reduction tool 601. For example, the design data store 611 may be a magnetic disk drive, a rewritable optical disk drive, a “punch” type memory device, a holographic memory device, etc. Of course, while a single design data store 611 device is illustrated in FIG. 6, alternate examples of the invention may employ two or more separate memory storage devices working in concert. With various examples of the invention, the design data store 611 may store the layout design data as part of a database for storing design data for use in one or more other electronic design automation processes. For example, the design data store 611 may store the layout design data as part of a hierarchical database used in conjunction with one or more physical verification or resolution enhancement technique tools, such as the family of Calibre software design tools available from Mentor Graphics Corporation of Wilsonville, Oreg.

As will be discussed in more detail below, the jog identification module 603 obtains layout design data from the design data store 611. With various examples of the invention, the jog identification module 603 will then identify the “jogs” in each polygon of the layout design data. Additionally, for each identified jog, the jog identification module 603 will identify if it has an opposing jog or edge that can be aligned with the identified jog. After the jog identification module 603 has determine one or more jog pairs, the feature identification module 605 will identify surrounding features of the jog pairs, such as adjacent vertices, jogs and edges.

Using the information gathered by the feature identification module 605, for each polygon the jog pair alignment selection module 607 will select which of the identified jog pairs should be aligned. More particularly, the jog pair alignment selection module 607 will determine if a target jog is alignable (that is, whether it can be aligned with an opposing jog or edge without violating an alignment constraint). The jog pair alignment selection module 607 also may determine a subset of alignable jog pairs that are preferred for alignment over other alignable jog pairs. For example, with some implementations of the invention, the jog pair alignment selection module 607 may determine a subset of alignable jog pairs that, when aligned, will still reduce the shot count for the polygon but also will minimize the total displacement of jogs and edges in the polygon. With various examples of the invention, the jog pair alignment selection module 607 may employ, e.g., linear programming, to determine which of the identified jog pairs is alignable, and which of the alignable jog pairs are preferred for alignment.

Once the jog pair alignment selection module 607 has selected jog pairs for alignment, the jog alignment module 609 will modify the layout design data to align the selected jog pairs. The jog alignment module 609 may then store the modified layout design data in the design data store 611. The modified layout design data may be used to replace the original layout design data, or it may be stored in conjunction with the original layout design data.

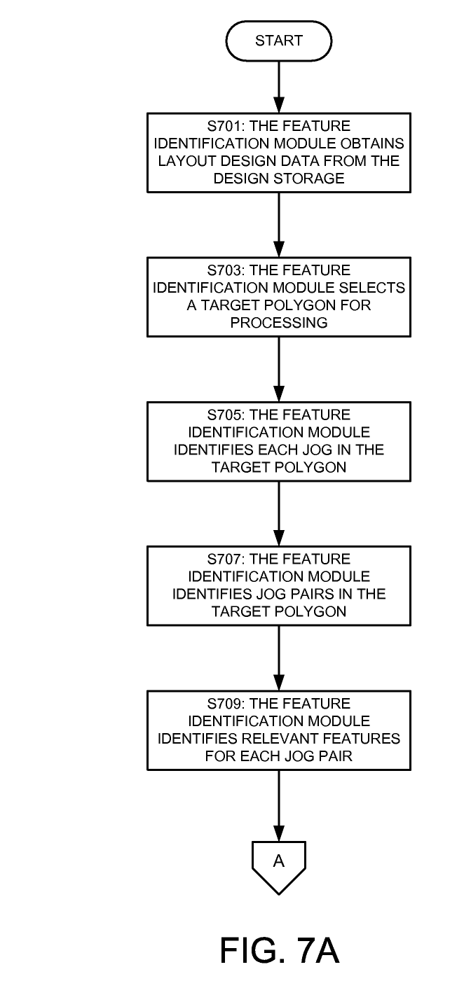

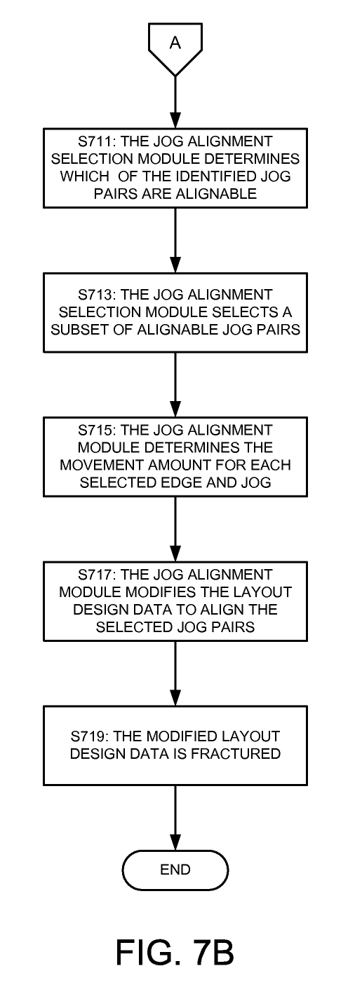

With various examples of the invention, the shot count reduction tool 601 may be implemented as part of another electronic design automation process, such as a resolution enhancement technique process. For example, use of the shot count reduction tool 601 may be incorporated into an optical proximity correction process. With these implementations, as the optical proximity correction process corrects a layout design data to improve the image resolution it will provide, the shot count reduction tool 601 will concurrently modify the layout design data to reduce the number of shots required to write a mask from the data. The operation of the shot count reduction tool 601 will be discussed in more detail below with regard to the flow chart illustrated in FIGS. 7A and 7B.

### Jog Identification

Referring now to FIG. 7A, in step 701 the jog identification module 603 obtains layout design data from the design data store 611. As used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

As will be appreciated by those of ordinary skill in the art, layout design data will include one or more geometric elements to be written to a mask or reticle. For conventional mask or reticle writing tools, the geometric elements typically will be polygons of various shapes. Thus, the layout design data usually include polygon data describing the features of polygons in the design. With various examples of the invention, the layout design data may include unfractured polygon data, previously-fractured polygon data being prepared for re-fracturing, or some combination thereof.

Next, the jog identification module 603 determines if there are any unprocessed polygons in the layout design data. If there is, then in step 703 the jog identification module 603 selects an unprocessed polygon for processing. In step 705, the jog identification module 603 identifies each jog in the target polygon. In addition to identifying each jog, with various examples of the invention the jog identification module 603 also will determine, for each jog, whether it has an opposing jog or edge with which it might be aligned in step 707.

As used herein, the term “jog” refers to an arrangement of polygon edges like the arrangement of polygon edges 801-805 illustrated in FIG. 8. As seen in this figure, a jog has a middle edge (e.g., edge 801) with a peripheral edge at one end extending in a first direction (e.g., edge 803) and another peripheral edge at the opposite end extending in a second direction opposite from the first direction (e.g., edge 805). Further, each of the peripheral edges is longer than a first length L1, while the middle edge is shorter than a second length L2. With various examples of the invention, the values of both L1 and L2 may be, e.g., 10 nm. It should be appreciated, however, that the values of L1 and L2 may be any desired values, and typically will be selected to distinguish shape variations along a side of a polygon that are deemed insignificant from those features of the polygon deemed important. For example, L2 may be equal to or less than L1, with L2 being relatively small in comparison with the characteristic minimum dimension of the device manufacturing process. It will be understood, however, that the selected values for L1 and L2 may vary as desired depending upon still other resolution enhancement considerations for the manufacturing process, such as the average electronic device size in the circuit, the wavelength of radiation that will be used during the subsequent photolithographic manufacturing process, the reduction in size from the mask size to the imaged size, etc.

With some embodiments of the invention, the jog identification module 603 may perform a scan analysis to identify both a jog (referred to herein as a “target” jog) and any opposing jog or edge with which the target job might be aligned. To perform the scan, the jog identification module 603 may sort the edges of the polygon by, e.g., their coordinate values in a Cartesian coordinate system. For example, the jog identification module 603 may initially sort the edges according to their x-coordinate values, and then by their y-coordinate values.

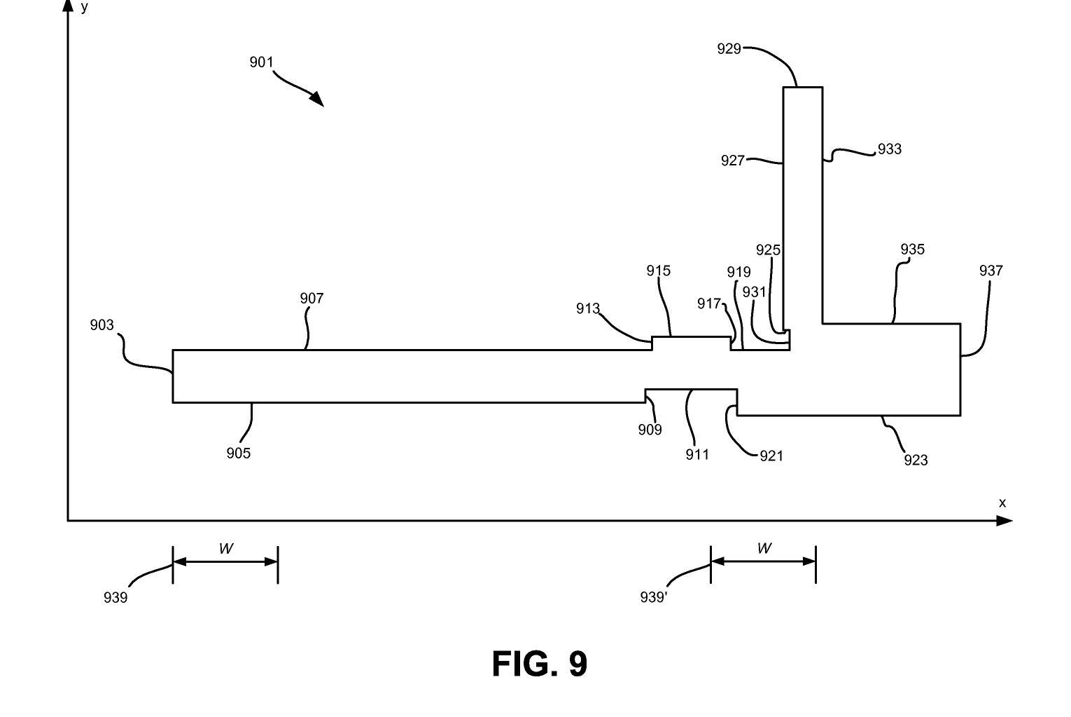

Referring now to FIG. 9, this figure shows an illustrative polygon 901 having edges 903-937. With various implementations of the invention, the edge 903 may thus be sorted first, as it has the lowest x-coordinate value (with no change in that x-coordinate value over its length). Among edges 905 and 907, which each share their lowest x-coordinate value, edge 905 is sorted next because its lowest y-coordinate value is less than the lowest y-coordinate value of edge 907. After edge 907 is sorted, edges 909 and 911 are sorted, respectively, as these edges have a smaller x-coordinate value than edge 913. Edges 913 and 915 then are sorted, as these edges share the next-lowest x-coordinate value. Similarly, edges 917 and 919 are sorted with the next-lowest coordinate value. The jog identification module 603 continues this process, until all of the edges 903-937 are sorted in order.

Once the jog identification module 603 has sorted all of the edges of a polygon, it reads them out in series to create a list of the edges that extend into a scanning band of a specified width. The band then can be moved across the area of the polygon, so that it includes each identified jog in turn. With various examples of the invention, the jog identification module 603 may first scan the edges extending in a first direction, rotate the process by 90°, and then scan the edges extending in a second direction orthogonal to the first direction. For example, referring to FIG. 9, the jog identification module 603 may first scan all of the edges extending in the x-axis or “horizontal” direction for jogs having a middle edge extending in the y-axis or “vertical” direction. Once all of the edges in the x-axis direction have been scanned, then the jog identification module 603 will rotate the analysis by 90° and repeat the scan. That is, the jog identification module 603 then will scan all of the edges in the y-axis direction for jogs having a middle edge extending in the x-axis direction.

Thus, with the polygon shown in FIG. 9, if a band of width W in the x-axis direction starts at an initial position 939, it will include the edges 903, 905 and 907. As the band moves, the list of edges falling within the band is updated to remove edges that fall out of the new band position and to add edges that fall within the new region encompassed for the band. When the band of width W illustrated in FIG. 9 is moved to a new position 939′, it will include the edges 911, 915, 917, 919, 921, 923, 925, 927, 929 and 931. In this manner, the jog identification module 603 can identify each target jog in turn. The use of a scan line to find proximate items to points in a set is a well known method, and thus will not be discussed here in more detail.

With various example of the invention, when the jog identification module 603 identifies a jog (i.e., a target jog), it also examines the edges of the polygon within the scanning band for an opposing jog or edge with which the target jog might be aligned. A jog is considered an opposing jog if it occurs on an opposite side of the polygon from the target jog, the middle edge of the jog is parallel to the middle edge of the target jog, and is within a predetermined distance D≦2dₘₐₓ of the middle edge of the target jog. As will be discussed in more detail below, dₘₐₓ is the maximum allowable movement for any edge in a direction orthogonal to the direction of that edge.

For example, referring back to FIG. 3A, the jog 303 has a middle edge that is on the opposite side of the polygon 201 from the jog 301, is parallel to the middle edge of the target jog 301, and is within a predetermined distance D of the middle edge of the target jog 301. Thus, the jog 303 is an opposing jog for the jog 301. Commutatively, the jog 301 is an opposing jog for the jog 303. Similarly, an edge will be considered an opposing edge if it occurs on an opposite side of the polygon from the middle edge of the target jog, is parallel to the middle edge of the target jog, and is within a predetermined distance D≦2dₘₐₓ of the middle edge of the target jog 301.

As will be appreciated by those of ordinary skill in the art, depending upon the polygon, a target jog may have no opposing jogs or edges, one opposing jog or edge, or two or more opposing jogs or edges. If a target jog has only as single opposing jog or edge, then the jog identification module 603 will associate the target jog with its opposing jog or edge as a jog pair. (As previously noted, the term “jog pair” is used herein for convenience and ease of understanding to refer to the combination of a jog and its opposing edge as well as a pair of opposing jogs.)

If, however, a target jog has two or more opposing jogs or edges, then the jog identification module 603 may select a single opposing jog or edge to pair with the target jog. With some implementations of the invention, for example, the jog identification module 603 may employ an algorithm for creating a maximum set of matching of items in a bipartite graph, in order to create the maximum number of jog pairs for a polygon. Various algorithms for determining the maximum set of matching of items in a bipartite graph are well known in the art, and will not be discussed in more detail here.

Still other implementations of the invention may instead select jog pairs by pairing the target jog with the closest opposing jog or edge along a direction orthogonal to the middle edge of the target jog. For example, if the jog identification module 603 is scanning horizontal edges, it will identify the vertical middle edge of a target jog. Next, it will identify the horizontal edge on the opposite side of the polygon that is nearest to the vertical middle edge of the target jog. From that opposing edge, the jog identification module 603 will identify the vertical edge the vertical edge of the polygon adjacent to the endpoint of that nearest opposing horizontal edge. If that opposing vertical edge is within the distance D from vertical middle edge of the target jog, then the jog identification module 603 will pair the opposing vertical edge with the target jog.

Thus, referring to FIG. 9, the jog identification module 603 may first identify the vertical edge 909 as the middle edge of the jog formed by edges 905, 909 and 911. The x-coordinate value of the vertical edge 909 falls within the range of x-coordinate values for the horizontal edge 907. Accordingly, the jog identification module 603 will identify vertical edge at the endpoint of the horizontal edge 907 closest to the vertical edge 909 (i.e., the closest opposing vertical edge in the horizontal direction). As seen in FIG. 9, this closest opposing vertical edge is the edge 913. The jog identification module 603 will then pair the edge 913 with the edge 909.

It should be appreciated that, while various implementations of the invention may employ the maximum bipartite graph matching or closest opposing parallel edge identification techniques discussed above for selecting jog pairs, still other implementations of the invention may employ alternate or additional techniques for selecting job pairs. For example, other selection techniques may be identified or developed for selecting jog pairs that will, upon alignment of at least some of these jog pairs, generate a smaller number of shot counts during fracturing. These other jog pair selection techniques may alternately or additionally be employed by various embodiments of the invention.

It also should be appreciate that, while FIG. 9 shows a polygon relative to a particular Cartesian coordinate system for convenience of reference and ease of understanding, this particular arrangement and orientation is provided for illustrative purposes only, and is not intended to be limiting. For example, some implementations of the invention may use any desired reference technique, such as, e.g., the use of polar coordinates. Similarly, while the terms “horizontal” and “vertical” are employed herein to refer to the x-axis and y-axis directions shown in FIG. 9, respectively, these terms likewise are intended to be illustrative rather than limiting. Further, while all of the edges of the polygon 901 are parallel to either the x-axis direction or the y-axis direction, it should be appreciated that various implementations of the invention may operate on polygons having edges at any angle. For example, some implementations of the invention may identify and align pairs of jogs in a polygon that are at a, e.g., 30°, 45°, and/or 60° angle to one or more other edges in the polygon.

Still further, other embodiments of the invention may alternately or additionally employ techniques different from the scanning band described above to identify target jogs and opposing jogs in a polygon. For example, with some embodiments of the invention, the jog identification module 603 may place all of the edges of the polygon in a quad tree or other spatial index. For each target jog, the jog identification module 603 will find its location in the tree, and query the tree to find all of the edges around it to identify the relevant opposing jogs, edges and vertices. Of course, any other desired technique or techniques can alternately or additionally be employed to identify a target jog and any relevant opposing jogs or edges.

### Constraint Feature Identification

Various implementations of the invention also may determine if aligning a target jog with an opposing jog violates an alignment constraint. As will be discussed in more detail below, the alignment constraints may prohibit movement of a jog beyond a maximum displacement distance, prohibit movement of a jog such that its middle edge is within a minimum distance from another edge or vertex of the polygon, prohibit movement of a jog such that either one of its peripheral edges is within a minimum distance from an edge of another polygon, etc. Accordingly, in step 709, the feature identification module 605 will identify one or more features of the target jog's polygon or adjacent polygons that may constrain movement of the target jog.

More particularly, with some embodiments of the invention, the feature identification module 605 may perform another scan analysis to identify the polygon features relevant to each target jog. Again, a region surrounding the target jog is analyzed for relevant polygon features. As discussed in detail above, the feature identification module 605 initially sorts the edges in the region, e.g., their x-coordinate values and then by their y-coordinate values. With some implementations of the invention, the feature identification module 605 may employ the same edge order generated by the jog identification module 603. With still other implementations of the invention, however, the feature identification module 605 may perform its own sorting of the edges in the polygon. It should be appreciated, however, that one or more features from polygons adjacent to the target polygon (i.e., the polygon containing the target jog) may constrain the alignment of the target jog, as will be discussed in more detail below. Accordingly, with various examples of the invention, the feature identification module 605 may include edges from one or more adjacent polygons in the scan region.

When the scanning reference point of a band reaches an identified jog (i.e., the target jog for that band position), the feature identification module 605 can efficiently query locally within the band to recognize edges and vertices that may be relevant to that target jog. The scanning band can be of any desired width in a particular direction, but its width may conveniently be determined by the alignment constraints. For example, as will be discussed in detail below, one alignment constraint that may be that the absolute movement of any edge will be limited to a small value dₘₐₓ. There may also be an alignment constraint that all vertices in a polygon must maintain a minimum separation distance of sₘᵢₙ. With these two alignment constraints, the width of the scanning band may be, for example, W≧2·(dₘₐₓ+sₘᵢₙ), to ensure that, even if the middle edge of an identified jog can be moved by its maximum amount to align with an opposing jog, the scanning band will include any vertices that may nonetheless prohibit the alignment. It should be appreciated, however, that alternate implementations of the invention may employ other scan widths. For example, if the alignment of jog pairs is restricted to movement in only one direction (e.g., a positive direction in an x-y Cartesian coordinate system), then the scan region may extend from the target jog in only that positive direction.

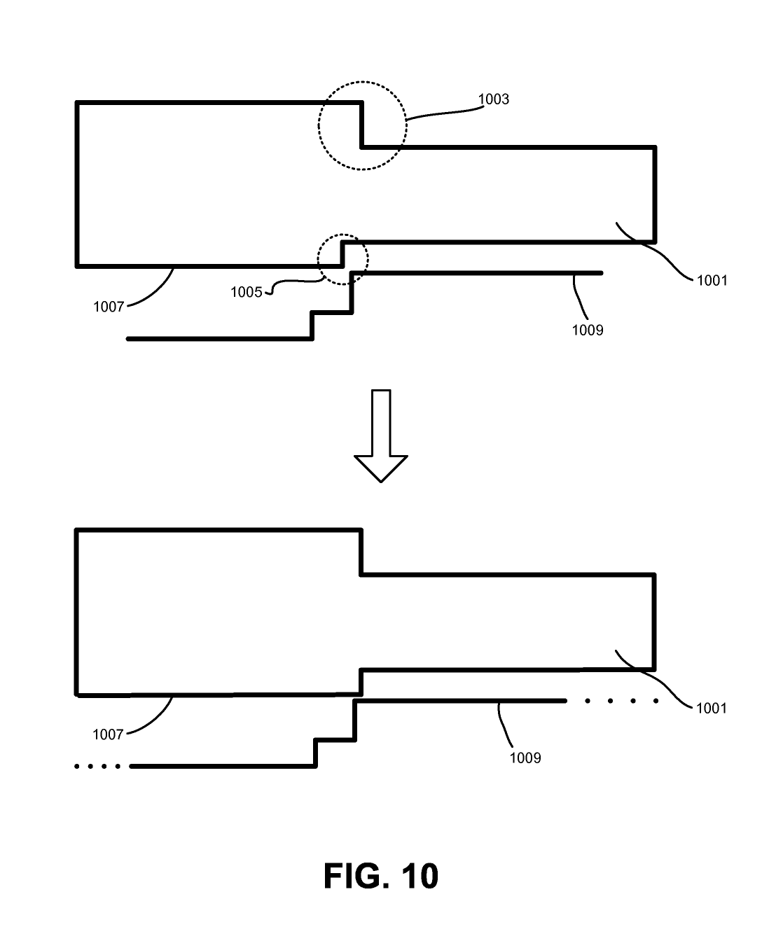

As previously noted, movement of a target jog also may be limited by features of adjacent polygons. For example, FIG. 10 illustrates a polygon 1001 with two jogs: jog 1003 and jog 1005, which includes a peripheral edge 1007. This figure also shows a portion of an adjacent polygon, which has an edge 1009. When only the characteristics of the polygon 1001 are considered, the jog 1005 can be aligned with jog 1003 by moving it toward the jog 1003. As seen in this figure, however, moving the jog 1005 toward the jog 1003 will cause its peripheral edge 1007 to be too close to the edge 1009 of the adjacent polygon. Accordingly, with various implementations of the invention, the feature identification module 605 will also identify relevant features in adjacent polygons. The feature identification module 605 may identify these features by, for example, simultaneously including the edges and vertices of adjacent polygons in the scanning band with the edges and vertices of the target polygon, as described above.

While various implementations of the feature identification module 605 may use a scanning band to identify relevant features in a polygon as discussed above, still other embodiments of the invention may alternately or additionally employ different techniques to identify features relevant to a target jog. For example, with some embodiments of the invention, the feature identification module 605 may place all of the edges of the polygon in a quad tree or other spatial index. For each target jog, the feature identification module 605 will find its location in the tree, and query the tree to find all of the edges around it to identify the relevant opposing jogs, edges and vertices. Of course, any other desired technique or techniques can alternately or additionally be employed to identify relevant opposing jogs, edges and vertices for a target jog.

### Jog Alignability

After the feature identification module 605 has identified the relevant edges and vertices for each jog pair in a polygon, the jog pair alignment selection module 607 selects jog pairs for alignment. More particularly, in step 711, the jog pair alignment selection module 607 determines which of the identified jogs are alignable with an opposing jog or edge. That is, for each identified jog pair, the jog pair alignment selection module 607 will determine if aligning the jog pair will violate any assigned alignment constraints.

As previously noted, various examples of the invention may impose one or more constraints on the alignment of an identified jog with an opposing jog or edge. Some constraints may be specified to prevent the alignment of jogs in a layout design from degrading the resolution of a mask or reticle created from the design. For example, an optical proximity correction process may intentionally add one or more shape characteristics to a polygon, in order to improve its reproduction resolution when that polygon is subsequently written to a mask or reticle. It might therefore be undesirable to remove those added shape characteristics, even if their deletion would reduce the shot count required to write the polygon to a mask or reticle.

Accordingly, various implementations of the invention may prohibit the absolute movement of any edge, such as a middle edge of a jog, from being moved more than a maximum movement value dₘₐₓ. A relatively small value can be selected for the maximum movement value to ensure, for example, that no alignment of a target jog with an opposing jog or edge will significantly alter the shape of their polygon. With various examples of the invention, the maximum movement value dₘₐₓ may be, e.g., 30 nm. Some implementations of the invention also may prohibit any vertex of the polygon from being within a minimum separation distance sₘᵢₙ from another vertex. The minimum separation distance sₘᵢₙ may be selected to ensure that, after the layout design has been written to a reticle or mask, the diffractive effects from one vertex do not significantly impact the diffractive effects of an adjacent vertex during a photolithographic manufacturing process, to ensure that the mask can be accurately examined during a subsequent inspection process, etc. With various examples of the invention, the minimum separation distance sₘᵢₙ may be, e.g., 60 nm. As will be discussed in more detail below, these constraints may be employed in a vector environment. Accordingly, with various implementations of the invention, one or both of these constraints may be measured using, e.g., the l-inf norm.

In addition to determining whether jog pairs are alignable based upon specified constraints, some implementations of the invention also may select only a subset of the alignable jog pairs for alignment. For example, as previously noted, a designer may wish to ensure that reducing the shot count does not in turn degrade improvements in the layout design created by an earlier resolution enhancement technique process. Accordingly, with various examples of the invention, in step 713 the jog pair alignment selection module 607 may additionally select only a subset of alignable jogs that would reduce or minimize the changes to the polygon. For example, the jog pair alignment selection module 607 may select only the subset of alignable jogs that would minimize the change in total area of the polygon, minimize the total cumulative movement of edges in the polygon, or some combination of both.

In addition to selecting a subset of alignable jogs to align, in step 715 the jog pair alignment selection module 607 will determine, for each jog pair, how much each jog or edge in the pair will be moved for alignment. For example, referring back to FIGS. 3A and 3B, the middle edge of the jog 301 is separated from the middle edge of the jog 303 by a distance Δ. It will be appreciated however, that the jog 301 can be aligned with the jog 303 by moving the middle edge of the jog 301, by moving the middle edge of the jog 303, or some combination of both. That is, the jogs 301 and 303 can be aligned by moving the middle edge of the jog 301 a distance of m toward the middle edge of the jog 303, and by moving the middle edge of the jog 303 a distance of Δ−m toward the middle edge of the jog 301, where m≦dₘₐₓ. Accordingly, for each jog pair, the jog pair alignment selection module 607 will determine the amount that the target jog should be moved toward the opposing jog or edge in order to align the jog pair. It also will determine the amount that the opposing jog or edge should be moved toward the target jog in order to align the jog pair.

With various examples of the invention, the jog pair alignment selection module 607 may simultaneously determine the alignability of each identified jog, select a subset of the alignable jog pairs, and determine the movement of each edge in the selected jog pairs using integer programming (IP), also known as integer linear programming (ILP). As known in the art, integer programming is a form of linear programming in which one or more of the variables are integers. As also known in the art, linear programming is a mathematical methodology used to determine the maximum (or minimum) solution of a linear function given a defined set of constraints.

For example, the standard form for linear programming (and integer programming) will take the format: maximize c^{T}x, subject to the constraints Ax≦b, and x≧0, where A, b, c, and x are vectors such that:

$${c}^{T} x = {c}_{1} {x}_{1} + {c}_{2} {x}_{2} + {c}_{3} {x}_{3} + … {c}_{n} {x}_{n} , \\ and$$

$${a}_{11} {x}_{1} + {a}_{12} {x}_{2} + {a}_{13} {x}_{3} + … {a}_{1 n} {x}_{n} \leq {b}_{1}$$

$${a}_{21} {x}_{1} + {a}_{22} {x}_{2} + {a}_{23} {x}_{3} + … {a}_{2 n} {x}_{n} \leq {b}_{2}$$

$${a}_{31} {x}_{1} + {a}_{32} {x}_{2} + {a}_{33} {x}_{3} + … {a}_{3 n} {x}_{n} \leq {b}_{3}$$

$$⋮$$

$${a}_{m} {x}_{1} + {a}_{m2} {x}_{2} + {a}_{m3} {x}_{3} + … {a}_{mn} {x}_{n} \leq {b}_{m} , \\ and$$

$${x}_{1} \geq 0 , {x}_{2} \geq 0 , {x}_{3} \geq 0 , … , {x}_{n} \geq 0.$$

Accordingly, the jog pair alignment selection module 607 may both determine the alignable jogs and select a subset of the alignable jogs by treating the selected subset of alignable jogs as a solution to an integer programming problem. Still further, the jog pair alignment selection module 607 also can determine the amount of movement of each selected edge as part of the integer programming problem solution. More particularly, the jog pair alignment selection module 607 can use the alignment constraints to create one or more constraint equations for each identified jog. For example, when the feature identification module 605 identifies one or more features relevant to a target jog (such as an opposing jog or edge), the jog pair alignment selection module 607 can create a constraint equation based upon both the target jog and one of the relevant features. With some implementations of the invention, when the feature identification module 605 identifies relevant features for a target jog, it may pass that information onto the jog pair alignment selection module 607 before analyzing the next target jog. In this manner, the constraint equations for the integer programming process can be generated as the relevant features for each target jog are identified.

Employing this technique, the jog pair alignment selection module 607 may generate an integer programming problem such that, for each vertical edge i and each horizontal edge j in a polygon, a variable hᵢ can represent the horizontal displacement of the vertical edge, the variable vⱼ can represent the vertical displacement of the horizontal edge, the constant xᵢ can represent the original (e.g., lowest) x-coordinate value of the corresponding vertical edge and the constant yⱼ can represent the original y-coordinate value of the corresponding horizontal edge. It should be noted that, because the displacement variables hᵢ and vⱼ represent movements of one jog or edge toward another jog or edge in a jog pair, these movements will comply with a non-negativity constraint. Using these representations, the alignment constraints for the polygon 901 show in FIG. 9 may be expressed as follows:

Non-negative alignment constraints:

hᵢvⱼ≧0∀i,j (1)

Maximum alignment constraints:

hᵢ,vⱼ≦dₘₐₓ∀i,j (2)

Minimum geometric separation constraints between jogs:

(x₉₁₇+h₉₁₇)−(x₉₁₃−h₉₁₃)≧min(sₘᵢₙ,x₉₁₇−x₉₁₃) (3)

(x₉₂₁+h₉₂₁)−(x₉₀₉−h₉₀₉)≧min(sₘᵢₙ,x₉₂₁−x₉₀₉) (4)

Minimum geometric separation constraints between jogs and edges:

x₉₃₁−(x₉₁₇−h₉₁₇)≧min(sₘᵢₙ,x₉₃₁−x₉₁₇) (5)

x₉₃₃−(x₉₂₁−h₉₂₁)≧min(sₘᵢₙ,x⁹³³−x₉₂₁) (6)

x₉₂₇−(x₉₁₇−h₉₁₇)≧min(sₘᵢₙ,x₉₂₇−x₉₁₇) (7)

(y₉₂₅+v₉₂₅)−y₉₁₉≧min(sₘᵢₙ,y₉₂₅−y₉₁₉) (8)

(y₉₂₅+v₉₂₅)−y₉₁₅≧min(sₘᵢₙ,y₉₂₅−y₉₁₅) (9)

Maximum alignment constraints provided by alignable edges:

(y₉₂₅+v₉₂₅)−y₉₁₉−y₉₃₅) (10)

Maximum alignment constraints provided by alignable jogs:

h₉₁₇+h₉₂₁≦x₉₂₁−x₉₁₇ (11)

h₉₀₉+h₉₁₃≦x₉₁₃−x₉₀₉ (12)

The objective function for the polygon 901, with the goal of selecting the alignment movements that will minimize the total displacements of all alignable jog-to-jog or jog-to-edge pairs, may be:

$$\begin{matrix}min ( ( ( {x}_{913} - {h}_{913} ) - ( {x}_{909} + {h}_{909} ) ) + ( ( {x}_{921} - {h}_{921} ) - ( {x}_{917} + {h}_{917} ) ) + ( {y}_{935} - ( {y}_{925} + {v}_{925} ) ) ) & ( 13 ) \\ or & \\ max ( {\sum }_{i} {h}_{i} + {\sum }_{j} {v}_{j} ) & ( 14 )\end{matrix}$$

As previously noted, various implementations of the invention may alternately or additionally select jog pairs for alignment so as to minimize the area change of the target polygons.

As known in the art, the jog pair alignment selection module 607 can use any of a variety of well-known integer programming solution techniques to determine the solution that minimizes the objective. If there is no solution for the objective equation, then the jog pair alignment selection module 607 will determine that no jog alignments should be made.

With still other embodiments of the invention, the jog pair alignment selection module 607 alternately may employ a conventional linear programming solution technique, such as the well-known simplex method, with an initial zero feasible solution. Once the jog pair alignment selection module 607 determines the optimized solution for the linear programming equations, it can then round the result to integer values. Again, if the rounded results cannot provide an exact alignment among the vertices in jog or jog-and-edge pairs, then no action will be taken.

It should be appreciated that, while the constraint requirements and objective function for a single polygon are described in detail above, various implementations of the jog pair alignment selection module 607 will be solved for all of the input edges input to the shot count reduction tool 601 (e.g., all of the polygons in the layout design data for a layer of an integrated circuit device). Solving the objective function for all of the input edges simultaneously will ensure that the alignment of any jog in one polygon will take into account the proximity of one or more characteristics of an adjacent polygon.

### Jog Alignment

Once the jog pair alignment selection module 607 has selected a set of jogs for alignment, the jog alignment module 609 will revise the layout design data to align the selected jogs in step 717. Once the layout design data has been updated to align the selected jogs, it can be stored in the memory 609. With some examples of the invention, the modified layout design data may be subject to further processing (e.g., further resolution enhancement techniques processing). In step 719, the modified layout design data then is fractured for use by a mask or reticle writing tool.

### CONCLUSION

While specification embodiments of the invention have been shown and described in detail above to illustrate the principles of the invention, it will be understood that the invention may be otherwise embodied with departing from the invention. For example, while specific terminology has been employed above to refer to electronic design automation processes, it should be appreciated that various examples of the invention may be implemented using any desired combination of electronic design automation processes.

Further, various examples of the invention discussed in detail above relate to layout design data for normal-tone masks and reticles (i.e., masks and reticles where the opaque portions of the mask or recticle will be within the polygons). It should be appreciated, however, that some implementations of the invention can be employed with layout design data for reverse-tone masks, where the opaque portions of the mask will be outside of the polygons. With these implementations, the alignment of jogs would be made for the areas of the layout design data outside of the polygons. Still further, while the various implementations of the invention discussed above limit movement of edges to only isothetic movements (i.e., parallel to a designated x-axis or y-axis direction), alternate examples of the invention may permit non-isothetic edge movements.

Moreover, various implementations of the invention may include one or more features to prevent the alignment of jog pairs in undesired areas. For example, some embodiments of the invention may allow a user to designate one or more areas of a design where no changes should be made, regardless of whether one or more jog pairs in the designated region are selected for alignment. Still other implementations may allow a user to designate regions where, e.g., the alignment of jog pairs must be manually approved by the user.

Thus, while the invention has been described with respect to specific examples including presently preferred modes of carrying out the invention, those of ordinary skill in the art will appreciate that there are numerous variations and permutations of the above described systems and techniques that fall within the spirit and scope of the invention as set forth in the appended claims.

What is claimed is:

1. A method of reducing shot counts for layout design data, comprising:
processing polygon data to identify one or more jogs in a layout design polygon;
selecting at least one alignable jog from among the identified one or more jogs in the layout design polygon, such that the alignable jog can be aligned with an opposing jog or edge by
moving the alignable jog toward the opposing jog or edge, or
moving the opposing jog or edge toward the alignable jog; and aligning the alignable jog with the opposing jog or edge by
moving the alignable jog toward the opposing jog or edge, or
moving the opposing jog or edge toward the alignable jog.

2. The method recited in claim 1, wherein selecting the alignable jog includes determining that aligning the alignable jog with the opposing jog or edge will not violate an alignment constraint.

3. The method recited in claim 2, wherein the alignment constraint is
movement of the alignable jog toward the opposing jog or edge by more than a maximum movement value, or
movement of the opposing jog or edge toward the alignable jog by more than the maximum movement value.

4. The method recited in claim 2, wherein the alignment constraint is a minimum distance between a middle edge of the alignable jog and an adjacent edge.

5. The method recited in claim 2, wherein the alignment constraint is a minimum distance between a middle edge of the alignable jog and a middle edge of an adjacent jog.

6. The method recited in claim 2, wherein the alignment constraint is a minimum distance between vertices in the layout design polygon.

7. The method recited in claim 1, wherein selecting the alignable jog includes
determining a plurality of target jogs from among the identified jogs that can be aligned with an opposing jog or edge;
determining a set of the target jogs that would result in the smallest change to the layout design polygon if aligned with opposing jogs or edges; and
selecting the alignable jog from among the determined set of target jogs.

8. The method recited in claim 7, wherein the change to the layout design polygon is a change in total area of the layout design polygon.

9. The method recited in claim 7, wherein the change to the layout design polygon is a total combined movement of edges in the layout design polygon.

10. The method recited in claim 1, further comprising, for each selected alignable jog
determining a distance that the alignable jog should be moved toward the opposing jog or edge to align the selected alignable jog with the opposing jog or edge, and
determining a distance that the opposing jog or edge should be moved toward the alignable jog to align the selected alignable jog with the opposing jog or edge.

11. The method recited in claim 1, further comprising selecting the at least one alignable jog from among the identified one or more jogs in the layout design polygon using integer linear programming.

12. A method of reducing shot counts for layout design data, comprising:
processing polygon data to identify one or more target jogs in a layout design polygon;
for each target jog,
determining if the target jog can be aligned with at least one opposing jog or edge, and
if the target jog can be aligned with at least one opposing jog or edge, then selecting an opposing jog or edge to pair with the target jog so as to form a jog pair;
identifying alignable jog pairs where the target jog can be aligned with the paired opposing jog or edge without violating an alignment constraint; and
aligning one or more of the alignable jog pairs.

13. The method recited in claim 12, wherein the alignment constraint is movement of the target jog toward the opposing jog or edge by more than a maximum movement value.

14. The method recited in claim 12, wherein the alignment constraint is movement of the opposing jog or edge toward the target jog by more than a maximum movement value.

15. The method recited in claim 12, wherein the alignment constraint is a minimum distance between the identified jog and an adjacent edge.

16. The method recited in claim 12, wherein the alignment constraint is a minimum distance between the identified jog and an adjacent jog.

17. The method recited in claim 12, wherein the alignment constraint is a minimum distance between the vertices in the layout design polygon.

18. The method recited in claim 12, further comprising, for each jog pair
defining a scan region; and
identifying features of the layout design polygon within the scan region that could cause alignment of the target jog with the paired jog or edge to violate an alignment constraint.

19. The method recited in claim 12, further comprising:
determining a set of the alignable jog pairs that would result in the smallest change to the layout design polygon if aligned; and
aligning only the determined set of the alignable jog pairs.

20. The method recited in claim 19, further comprising, for each of the determined set of alignable jog pairs,
determining a distance that the target jog should be moved toward the opposing jog or edge, and
determining a distance that the opposing jog or edge should be moved toward the target jog.

21. The method recited in claim 19, wherein the change to the layout design polygon is a change in total area of the layout design polygon.

22. The method recited in claim 19, wherein the change to the layout design polygon is a total combined movement of edges in the layout design polygon.

23. The method recited in claim 12, wherein determining if each target jog can be aligned with at least one opposing jog or edge includes
for each target jog, defining a scan region relative to the target jog; and
identifying opposing jogs or edges of the layout design polygon within the scan region that oppose the target jog.

24. The method recited in claim 12, further comprising fracturing the polygon data after aligning the one or more of the alignable jog pairs.

25. The method recited in claim 12, further comprising
identifying alignable jog pairs where the target jog can be aligned with the paired opposing jog or edge without violating an alignment constraint using integer linear programming.

26. A shot count reduction tool, comprising:
a jog identification module configured to
process polygon data to identify one or more target jogs in a layout design polygon, and
for each target jog,
determine if the target jog can be aligned with at least one opposing jog or edge, and
if the target jog can be aligned with at least one opposing jog or edge, then select an opposing jog or edge to pair with the target jog so as to form a jog pair; and
a jog pair alignment selection module configured to identify alignable jog pairs where the target jog can be aligned with the paired opposing jog or edge without violating an alignment constraint.

27. The shot count reduction tool recited in claim 26, wherein the jog pair alignment selection module is configured to identify alignable jog pairs that do not violate an alignment constraint selected from the group consisting of:
movement of the target jog toward the opposing jog or edge by more than a maximum movement value,
movement of the opposing jog or edge toward the target jog by more than a maximum movement value,
a minimum distance between the target jog and an adjacent edge,
a minimum distance between the target jog and an adjacent jog, and
a minimum distance between vertices in the layout design polygon.

28. The shot count reduction tool recited in claim 26, further comprising:
a feature identification module configured to identify features of the layout design polygon that could cause alignment of the target jog with the paired jog or edge to violate an alignment constraint.

29. The shot count reduction tool recited in 28, wherein the jog pair alignment selection module is configured to identify alignable jog pairs that do not violate an alignment constraint selected from the group consisting of:
movement of the target jog toward the opposing jog or edge by more than a maximum movement value,
movement of the opposing jog or edge toward the target jog by more than a maximum movement value,
a minimum distance between the target jog and an adjacent edge,
a minimum distance between the target jog and an adjacent jog, and
a minimum distance between vertices in the layout design polygon.

30. The shot count reduction tool recited in 28, wherein the feature identification module is configured to, for each jog pair define a scan region;
identify features of the layout design polygon within the scan region; and
determine if an identified feature within the scan region would cause alignment of the target jog with the paired jog or edge to violate an alignment constraint.

31. The shot count reduction tool recited in claim 26, wherein the jog pair alignment selection module is further configured to determine a set of the alignable jog pairs that would result in the smallest change to the layout design polygon if aligned; and
select only the determined set of alignable jog pairs for alignment by the jog alignment module.

32. The shot count reduction tool recited in claim 31, wherein the change to the layout design polygon is a change in total area of the layout design polygon.

33. The shot count reduction tool recited in claim 31, wherein the change to the layout design polygon is a total combined movement of edges in the layout design polygon.

34. The shot count reduction tool recited in claim 26, further comprising:
a jog alignment module configured to align one or more of the identified alignable jog pairs.
